(19) United States
(12) Patent Application Publication
(10) Pub. No.: US 2011/0293996 A1
(43) Pub. Date: Dec. 1, 2011

(54) STACKED SECONDARY BATTERY AND PRODUCTION METHOD THEREOF

(75) Inventors: Takao Daidoji, Kanagawa (JP); Isao Tochihara, Kanagawa (JP); Yuuki Hori, Kanagawa (JP); Koichi Zama, Kanagawa (JP)

(73) Assignee: NEC ENERGY DEVICES, LTD., Kanagawa (JP)

(21) Appl. No.: 13/147,955

(22) PCT Filed: May 20, 2009
(86) PCT No.: PCT/JP2009/059252

§ 371 Date: Aug. 4, 2011

(51) Int. Cl. H01M 2/24; H01M 10/02; H01M 10/00; H01M 2/30

(52) U.S. Cl. 429/158; 429/179; 29/623.2

(57) ABSTRACT

In a stacked secondary battery, positive electrodes 5 and negative electrodes 4, which are formed by integrally forming a positive electrode collector tab 57 and a negative electrode collector tab 47 on a metal foil positive electrode collector 51 and a metal foil negative electrode collector 41, respectively, are stacked together with separators 6 disposed in-between. The separator 6 is also disposed between the opposing parts 8 of the positive electrode collector tab and the negative electrode collector tab. A positive electrode lead 17 and a negative electrode lead 15, connected to the positive electrode collector tab and the negative electrode collector tab, respectively, extend out from the same end surface of the stack of the positive electrodes 5 and the negative electrodes 4 and are drawn out from an outer casing 3.

### TECHNICAL FIELD

The present invention relates to stacked secondary batteries, such as lithium ion batteries, and methods for producing stacked secondary batteries, as well as to assembled batteries using such stacked secondary batteries.

### BACKGROUND ART

A stacked secondary battery, such as a lithium ion battery, consists of a stack of positive electrodes and negative electrodes that are stacked together in an opposing manner with separators disposed in-between. A positive electrode includes a current collector in the form of an aluminum foil coated with a positive electrode active material. A negative electrode includes a current collector in the form of a copper foil coated with a negative electrode material. Each electrode has a collector tab connected thereto and the collector tabs of the electrodes are stacked and joined together to provide an input/output portion for current.

FIG. 8 illustrates a conventional technique for making a collector tab. Specifically, FIG. 8A is a plan view of a negative electrode before it is cut to form a negative electrode collector tab. FIG. 8B is a plan view of a positive electrode before it is cut to form a positive electrode collector tab.

A negative electrode collector tab 47 is formed by first applying coating of a negative electrode active material to form a negative electrode active material coated area 43, and subsequently cutting a negative electrode active material uncoated area 45 along a cut line 9 by punching, thus leaving a rectangular part of the uncoated area 45 connected to the coated area 43.

Similarly, a positive electrode collector tab 57 is formed by first applying coating of a positive electrode active material to form a positive electrode active material coated area 53, and subsequently cutting a positive electrode active material uncoated area 55 along a cut line 9 by punching, thus leaving a rectangular part of the uncoated area 55.

Both negative and positive collectors are formed of a metal foil that is several to several tens of micrometers in thickness.

Since the cut lines that surround each of the negative electrode collector tab 47 and the positive electrode collector tab 57 are relatively short as compared to the width of the electrode, and since each of the negative electrode and the positive electrode is formed only of a thin metal foil except where the active material layer is deposited, burring is likely to occur when the part formed only of the metal foil is cut.

Since the formation of burrs may lead to short circuits and other problems during the long-term use of the batteries, the metal foil needs to be inspected after being cut to detect any burr and properly de-burred. This extra process results in decreased production efficiency.

### PRIOR-ART DOCUMENT

### Patent Document

Patent Document 1: JP-A-09-129211

### SUMMARY OF INVENTION

### Technical Problem

Accordingly, an object of the present invention is to provide a stacked secondary battery that can be produced without any burrs being formed on collective tabs during their formation. The present invention is intended for stacked secondary batteries, such as stacked lithium ion secondary batteries, in which a layer of an electrode active material is deposited on a metal foil current collector and the electrode active material uncoated part of the collector is drawn out to serve as the collector tab. To make such batteries, electrodes are stacked together and the current tabs are stacked and connected to one another. Electrode leads of the battery are then connected to the stacked collector tabs and the stack is sealed in an outer casing.

### Solution to Problem

The present invention is a stacked secondary battery, including a positive electrode collector formed of a metal foil and a negative electrode collector formed of a metal foil; a positive electrode formed of the positive electrode collector including a positive electrode active material coated area coated with a positive electrode active material and a positive electrode active material uncoated area not coated with the positive electrode active material, the positive electrode active material uncoated area serving as a positive electrode collector tab; a negative electrode formed of the negative electrode collector including a negative electrode active material coated area coated with a negative electrode active material and a negative electrode active material uncoated area not coated with the negative electrode active material, the negative electrode active material uncoated area serving as a negative electrode collector tab; a separator disposed between the positive electrode and the negative electrode, in which the positive electrode collector tab and the negative electrode collector tab are stacked together with a part of the positive electrode collector tab opposing a part of the negative electrode collector tab, and the separator is also disposed between the opposing parts of the collector tabs; and a positive electrode lead connected to the positive electrode collector tab and a negative electrode lead connected to the negative electrode collector tab, in which the positive electrode lead and the negative electrode lead extend out from the same end surface of the stack of the positive electrode, the separator and the negative electrode, and are drawn out from an outer casing.

Also, the present invention is the above-described stacked secondary battery, in which the active material coated areas of the negative electrode and the positive electrode each have a rectangular shape, and the positive electrode tab and the negative electrode tab each have a decreasing width as the positive electrode tab and the negative electrode tab extend away from the boundary with the positive electrode active material coated area or the negative electrode active material coated area.

Also, the present invention is the above-described stacked secondary battery, in which the positive electrode tab and the negative electrode tab have a substantially triangular, trapezoidal, or pentagonal shape.

The present invention is the above-described stacked secondary battery, in which the part of the separator that opposes the positive electrode collector tab and the negative electrode collector tab has a nonporous film applied thereto or is treated by a heat-clogging process.

The present invention is the above-described stacked secondary battery, in which the positive electrode active material includes a lithium-manganese composite oxide.

Also, the present invention is a method for producing a stacked secondary battery, including applying a paste of a positive electrode active material or a negative electrode active material to at least one surface of a band-shaped metal foil along the length of the band while providing an uncoated area for forming a collector tab; forming a unit electrode body by cutting the band along the length so that the cut band has a width equal to the width of a positive electrode or a negative electrode; forming a positive electrode and a negative electrode having a collector tab by cutting the uncoated area of the unit electrode body along one or two cut lines extending across the width of the body so that the cut uncoated area has a decreasing width as the uncoated area extends away from the boundary with the active material coated area; stacking the positive electrode and the negative electrode together with a separator disposed in-between; connecting the collector tabs of the positive electrodes and the negative electrodes with one another and connecting a positive electrode lead and a negative electrode lead to the respective electrode tabs; and sealing the stack in a film-like casing.

Also, the present invention is an assembled battery, including a positive electrode collector formed of a metal foil and a negative electrode collector formed of a metal foil; a positive electrode formed of the positive electrode collector including a positive electrode active material coated area coated with a positive electrode active material and a positive electrode active material uncoated area not coated with the positive electrode active material, the positive electrode active material uncoated area serving as a positive electrode collector tab; a negative electrode formed of the negative electrode collector including a negative electrode active material coated area coated with a negative electrode active material and a negative electrode active material uncoated area not coated with the negative electrode active material, the negative electrode active material uncoated area serving as a negative electrode collector tab; a separator disposed between the positive electrode and the negative electrode, in which the positive electrode collector tab and the negative electrode collector tab are stacked together with a part of the positive electrode collector tab opposing a part of the negative electrode collector tab, and the separator is also disposed between the opposing parts of the collector tabs; and a positive electrode lead connected to the positive electrode collector tab and a negative electrode lead connected to the negative electrode collector tab, in which the positive electrode lead and the negative electrode lead extend out from the same end surface of the stack of the positive electrode, the separator and the negative electrode, and are drawn out from an outer casing, and the positive electrode leads or the negative electrode leads of a stacked battery are connected in series, in parallel, or in series-parallel.

In constructing the stacked battery of the present invention, an active material is applied to a positive electrode collector and a negative electrode collector formed of a metal foil over an area thereof. The positive electrode active material uncoated area and the negative electrode active material serve as a positive electrode collector tab and a negative electrode collector tab, respectively. When positive electrodes and negative electrodes are stacked together with their respective active material layers facing each other and with a separator deposited in-between, the positive electrode collector tab and the negative electrode collector tab are arranged so that they have opposing parts with a separator disposed in-between. A positive electrode lead and a negative electrode lead, connected to the positive electrode collector tab and the negative electrode collector tab, respectively, are drawn out from the same end surface of the stack. This construction allows the positive electrode collector tab and the negative electrode collector tab to be cut from the collector without forming any burred edges. Thus, the stacked secondary battery of the present invention can be produced effectively. In addition, an assembled battery using the stacked secondary battery can be provided.

### BRIEF DESCRIPTION OF DRAWINGS

FIG. 1 is a diagram illustrating one embodiment of a stacked secondary battery of the present invention.

FIG. 2 is a diagram illustrating a series of steps in the production of the stacked secondary battery in one embodiment of the present invention.

FIG. 3 is a diagram illustrating a method for producing a positive electrode and a negative electrode.

FIG. 4 is a diagram illustrating a series of steps in the production of the stacked secondary battery in another embodiment of the present invention.

FIG. 5 is a diagram illustrating another method for producing the positive electrode and the negative electrode in another embodiment of the present invention.

FIG. 6 is a diagram illustrating a production process of an electrode of the present invention.

FIG. 7 is a diagram illustrating an assembled battery.

FIG. 8 is a diagram illustrating a conventional method for producing a collector tab.

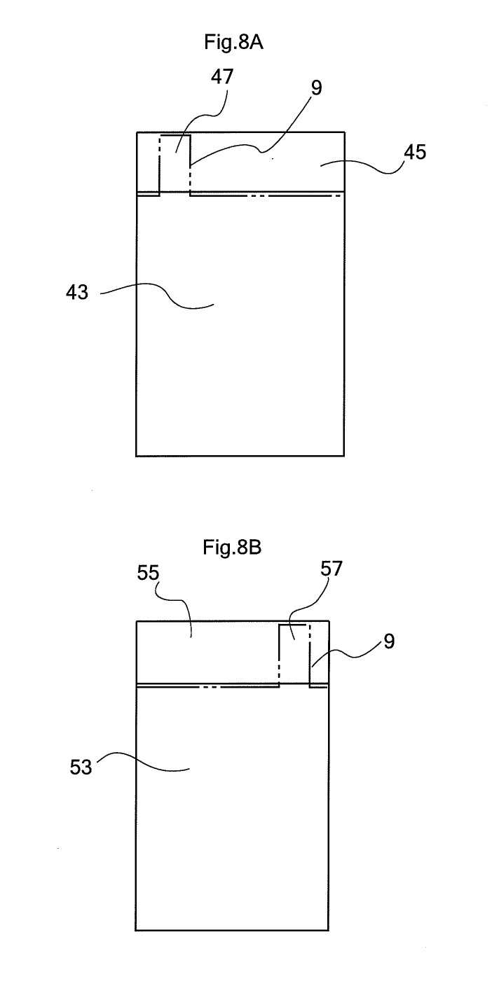

### BEST MODE FOR CARRYING OUT THE INVENTION

As described above, in order to produce a positive electrode and a negative electrode of a collector made of a metal foil, a positive electrode active material uncoated part where a positive electrode active material is not applied and a negative electrode active material uncoated part where a negative electrode active material is not applied are respectively cut to form a positive electrode collector tab and a negative electrode collector tab. The present inventor has found that the formation of burrs in the positive and negative electrode collector tabs, which otherwise would occur especially when the collector tabs are made of a thin member, such as the metal foil, can be prevented by cutting the positive and negative electrode collector tabs into a specific shape.

The present invention will now be described with reference to the drawings.

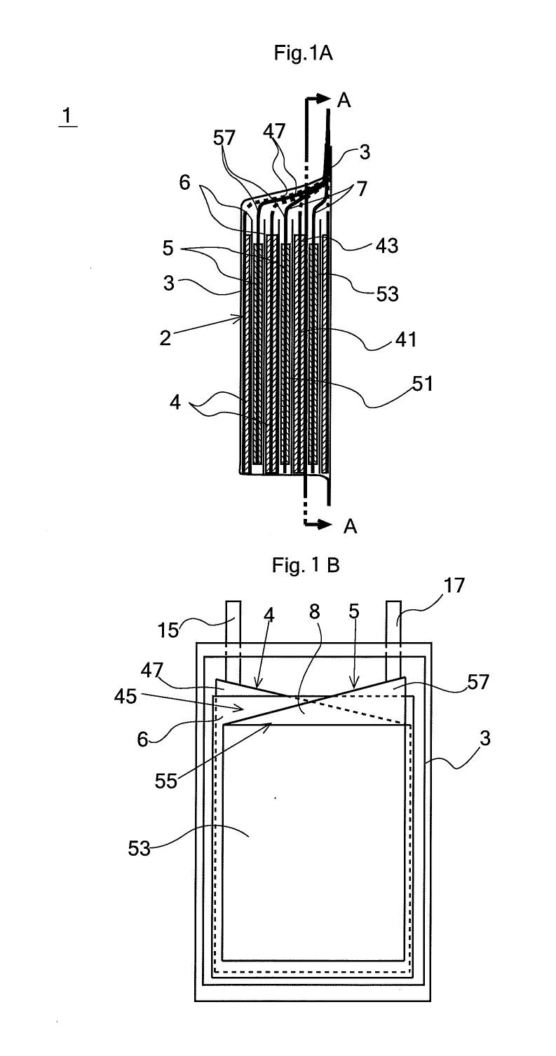

FIG. 1 is a diagram showing one embodiment of a stacked secondary battery of the present invention.

FIG. 1A is a cross-sectional view taken along a plane perpendicular to a stacked plane of a stacked secondary battery. FIG. 1B is a cross-sectional view taken along line A-A in FIG. 1A.

A stacked secondary battery 1 of the present invention includes a battery element 2 encased in a film-like casing 3. The battery element 2 consists of negative electrodes 4 and positive electrodes 5 that are stacked together with separators 6 disposed in-between. The separator 6 is made of a porous synthetic resin film.

The negative electrode 4 consists of a negative electrode collector 41 that includes a negative electrode active material coated area 43 coated with a negative electrode active material and a negative electrode active material uncoated area 45 that is not coated with the negative electrode active material. A negative electrode collector tab 47 is formed across a part or the entire width of the negative electrode active material uncoated area.

The negative electrode collector tab as illustrated in FIG. 1B extends from the coated area in a tapered manner so that the negative electrode collector tab has a decreasing width that equals the width of the negative electrode adjacent to the negative electrode active material coated area and decreases as the collector tab extends toward its tip portion.

Likewise, the positive electrode 5 consists of a positive electrode collector 51 that includes a positive electrode active material coated area 53 coated with a positive electrode active material and a positive electrode active material uncoated area 55 that is not coated with the positive electrode active material. A positive electrode collector tab 57 is formed across a part or the entire width of the positive electrode active material uncoated area.

As with the negative electrode collector tab, the positive electrode collector tab 57 extends from the coated area in a tapered manner so that the positive electrode collector tab 57 has a decreasing width that equals the width of the positive electrode adjacent to the coated area and decreases as the collector tab extends toward its tip portion.

The separator 6 is disposed between the negative electrode 4 and the positive electrode 5.

In the stacked secondary battery of the present invention, each of the positive electrode collector tab and the negative electrode collector tab is integrally formed with the current collector and has a tapered shape that has a decreasing width that equals the width of the positive or the negative electrode adjacent to their respective coated areas and decreases as the collector tab extends toward its tip portion.

The separator 6 is disposed so as to cover the area over which the negative electrode collector tab 47 opposes the positive electrode collector tab 57. Specifically, the separator 6 is arranged so as to cover the substantially triangular overlapping opposing area 8 that is formed when the negative electrode collector tab 47 is projected onto the positive electrode collector tab 57 as shown in FIG. 1B.

In this manner, no electrical short-circuit occurs between the negative electrode collector tab 47 and the positive electrode collector tab 57 in the substantially triangular opposing area when the positive electrodes and the negative electrodes with the respective opposing negative electrode collector tabs 47 and positive electrode collector tabs 57 are stacked together.

A negative electrode lead 15 is connected to the negative electrode collector tabs 47 and a positive electrode lead 17 is connected to the positive electrode collector tabs 57.

As described above, the stacked secondary battery can be produced in the following manner: the negative and positive electrodes are first stacked together with the separators disposed in-between and the collector tabs of the respective electrodes are connected with each other. The negative electrode lead and the positive electrode lead are then connected to the respective collector tabs. After the inside is filled with an electrolyte solution, the negative electrode lead 15 and the positive electrode lead 17 are drawn out from the sealed area of the film-like casing 3 to complete the stacked secondary battery.

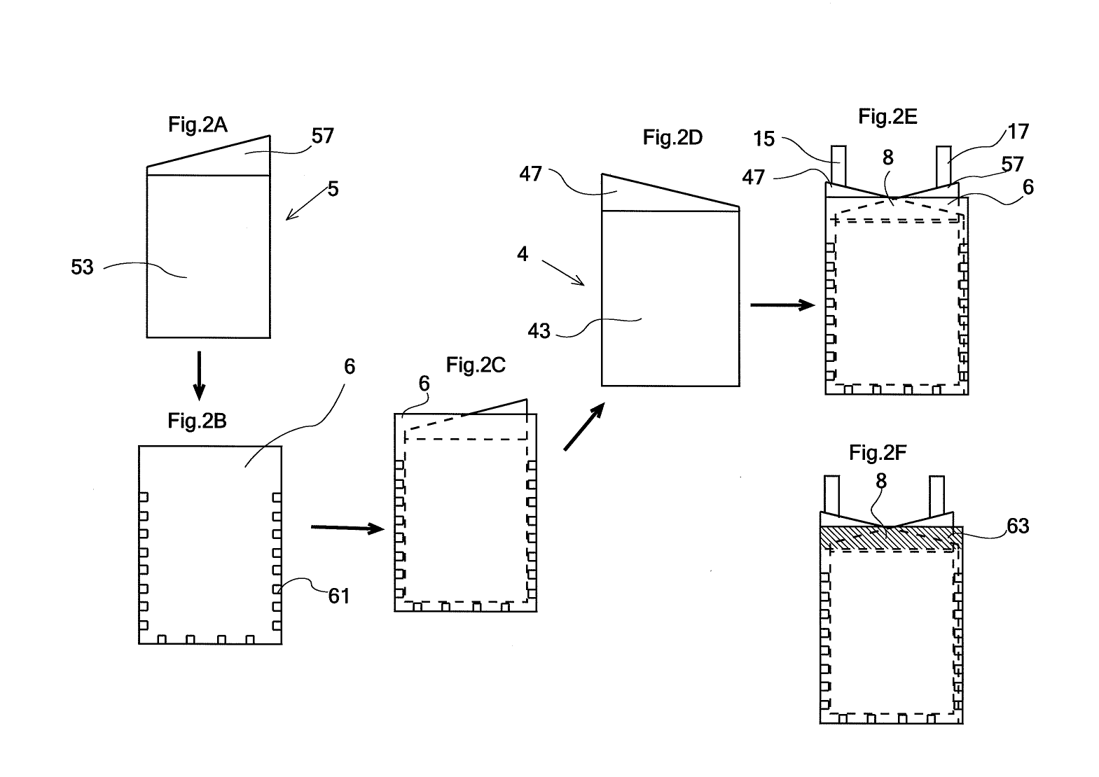

FIG. 2 is a diagram illustrating a series of steps in the production of the stacked secondary battery in one embodiment of the present invention.

FIG. 2A illustrates a positive electrode 5 that includes a positive electrode active material coated area 53 coated with a positive electrode active material and a positive electrode collector tab 57 formed of the positive electrode active material uncoated area that is not coated with the positive electrode active material.

The positive electrode collector tab is formed of a substantially triangular positive electrode active material uncoated area, one side of which is formed as the extension of the outer periphery of the electrode active material coated area, and another side of which is formed by the boundary with the negative electrode active material coated area.

FIG. 2B is a diagram illustrating a separator 6 in one embodiment of the present invention that is essentially a pouch with the three sides having discontinuous fused portions 61.

The fused portions 61 serve to define the width of the inside of the separator to correspond to the width of the positive electrode 5, so that when fitted in the separator 6, the positive electrode 5 is properly positioned by the fused portions 61 on the three sides thereof.

FIG. 2D is a diagram illustrating a negative electrode 4 in one embodiment of the present invention that includes a negative electrode active material coated area 43 coated with a negative electrode active material and a negative electrode active material uncoated area that is not coated with the negative electrode active material. A negative electrode collector tab 47 is formed in the negative electrode active material uncoated area.

The negative electrode collector tab is formed of a substantially triangular negative electrode active material uncoated area, one side of which is formed as the extension of the outer periphery of the electrode active material coated area, and another side of which is formed by the boundary with the negative electrode active material coated area.

FIG. 2E is a diagram illustrating the manner in which the separator with the positive electrode inserted therein as shown in FIG. 2C is stacked with the negative electrode shown in FIG. 2D.

Since the positive electrode 5 is positioned relative to the separator 6 by the fused portions 61 within the separator 6 as described with reference to FIG. 2C, the positive electrode 5 and the negative electrode 4 can be easily positioned relative to each other with the separator in-between by aligning the two right angle corners of the outer periphery of the separator 6 with the two corners of the negative electrode 4. In this manner, a stack can be produced in which the negative electrode and the positive electrode are accurately positioned relative to each other.

As described above, the positive electrode can be positioned by the fused portions provided in the separator and the negative electrode can be positioned by the periphery of the separator.

In this manner, the positive electrodes and the negative electrodes can be easily stacked together while accurately positioned relative to one another.

As shown in FIG. 2E, the presence of the separator in the opposing area 8 between the negative electrode collector tab 47 and the positive electrode collector tab 57 can prevent electrical short circuits between the negative electrode collector tab 47 and the positive electrode collector tab 57.

As described above, a predetermined number of negative electrodes, separators and positive electrodes are stacked together. The negative electrode collector tabs 47 and the positive electrode collector tabs 57 are then connected to one another. Subsequently, the negative electrode lead 15 is connected to the negative electrode collector tabs 47 and the positive electrode lead 17 is connected to the positive electrode collector tabs 57. The stack is then encased in the film-like casing and sealed.

FIG. 2F is a diagram illustrating another embodiment of the present invention.

In FIG. 2F, a non-porous film 63 to serve as the separator 6 is applied to the area corresponding to the opposing area 8 between the negative electrode collector tab 47 and the positive electrode collector tab 57. By applying the nonporous film, the contact between the negative electrode collector tab 47 and the positive electrode collector tab 57 can be effectively prevented in the opposing area 8 between the negative electrode collector tab 47 and the positive electrode collector tab 57.

As an alternative to the nonporous film, the separator 6 in the opposing area 8 between the negative electrode collector tab 47 and the positive electrode collector tab 57 may be subjected to a heat-clogging process or heat-clogging process followed by a stacking process.

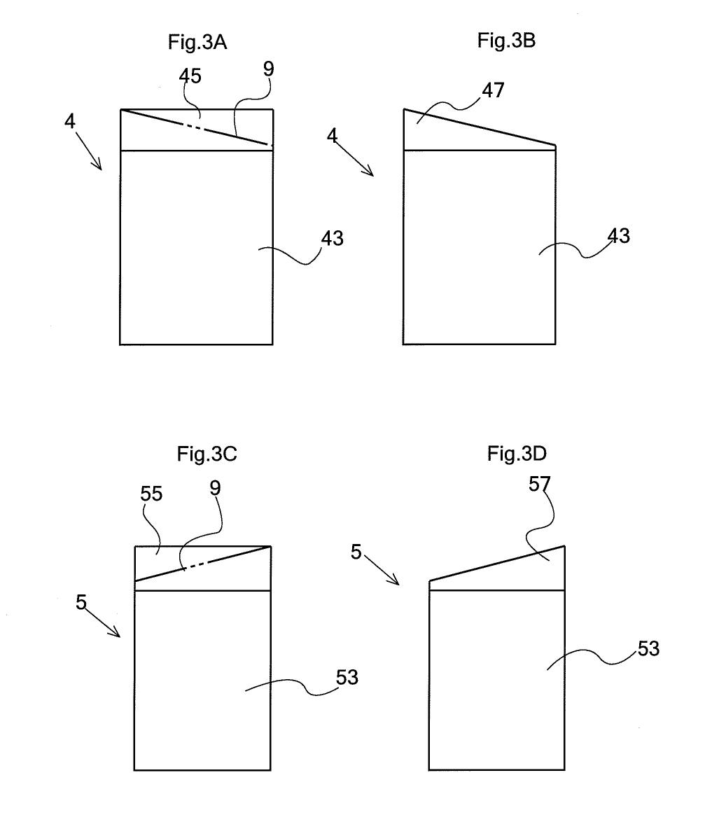

FIG. 3 is a diagram illustrating a method for producing a positive electrode and a negative electrode with FIGS. 3A and 3B illustrating negative electrode and FIGS. 3C and 3D illustrating positive electrode.

In FIG. 3A, a negative electrode collector includes a negative electrode active material coated area 43 that is coated with a negative electrode active material and a negative electrode active material uncoated area 45 that is not coated with the negative electrode active material and serves as the negative electrode collector tab 47.

The negative electrode active material uncoated area is cut along cut line 9 to make a negative electrode with the negative electrode collector tab 47 formed thereon as shown in FIG. 3B.

Cutting the part of the negative electrode collector formed of negative electrode active material uncoated metal foil along the straight cut line as shown in the figure does not lead to formation of burrs.

The positive electrode can be made in a similar manner to the negative electrode. In FIG. 3C, a positive electrode collector includes a positive electrode active material coated area 53 and a positive electrode active material uncoated area 55 that is not coated with the positive electrode active material and serves as the positive electrode collector tab 57. The uncoated area 55 is cut along cut line 9 to make positive electrode with the positive electrode collector tab 57 formed thereon as shown in FIG. 3D.

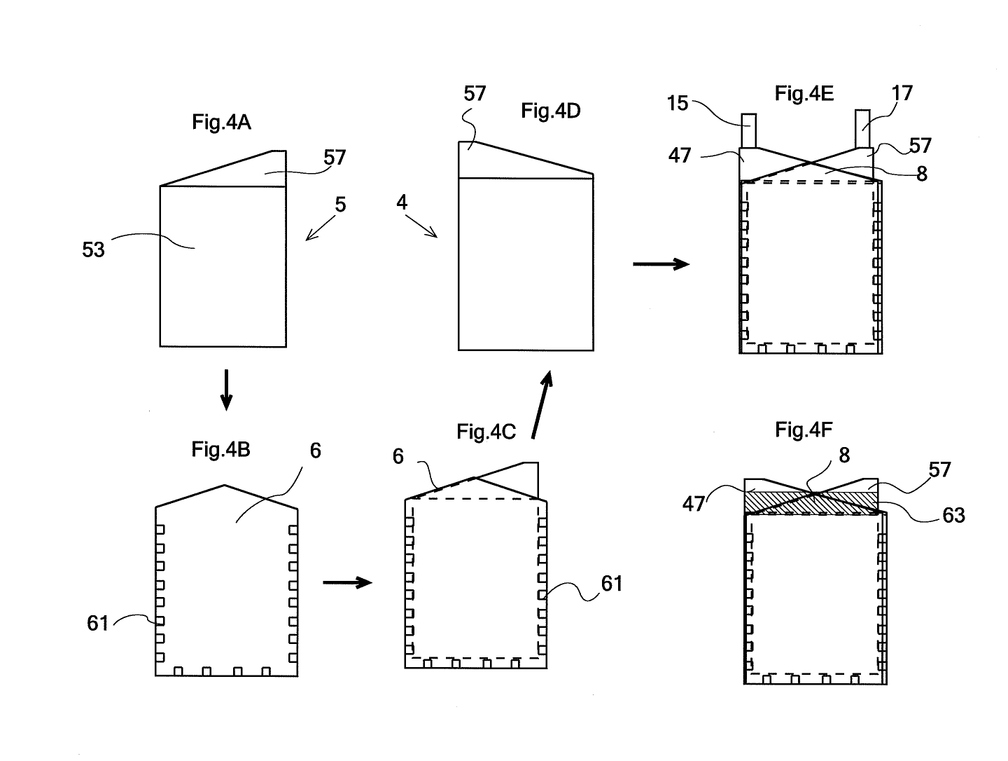

FIG. 4 is a diagram illustrating a series of steps in the production of the stacked secondary battery in another embodiment of the present invention.

The stacked secondary battery described with reference to FIG. 4 is similar to the embodiment described with reference to FIG. 2, except for the shape of the upper end portions of the negative electrode collector tab and the positive electrode collector tab and the shape of the separator.

Specifically, as shown in FIGS. 4A and 4D, the negative electrode collector tab 47 is different in that it has a trapezoidal shape with the negative electrode lead terminal attachment portion on the upper end of the positive electrode collector tab 57 and the negative electrode lead terminal attachment portion are parallel to the boundary between the active material coated layers of the negative electrode and the positive electrode and the active material uncoated area.

The negative electrode collector tab 47 and the positive electrode collector tab are formed as a substantially trapezoidal negative electrode active material uncoated area, one side of which is formed as the extension of the outer periphery of the electrode active material coated area, another side of which is the boundary with the negative electrode active material coated area, and another side of which is parallel to the boundary with the negative electrode active material coated area.

The separator 6 is different in that the upper end of the separator 6 has a substantially triangular periphery so that it can cover the area over which the negative electrode collector tab 47 opposes the positive electrode collector tab 57. Specifically, the separator 6 covers the substantially triangular overlapping area 8 that is formed when the negative electrode collector tab 47 is projected onto the positive electrode collector tab 57.

As described above, the shape of the negative electrode collector tab, the positive electrode collector tab and the separator is modified so that the separator does not exist where the negative electrode collector tab does not oppose the positive electrode collector tab. This facilitates handling of the negative electrode collector tab and the positive electrode collector tab.

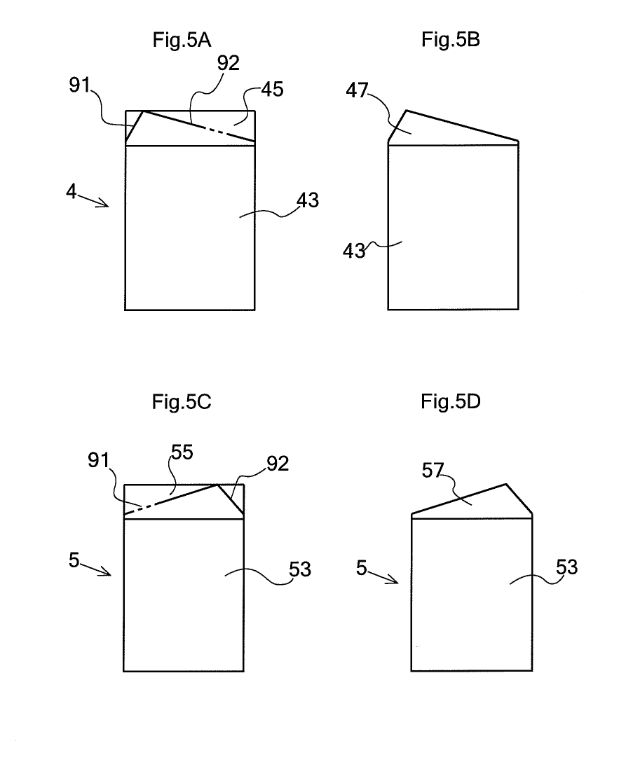

FIG. 5 is a diagram illustrating another method for producing the positive electrode and the negative electrode in another embodiment of the present invention. FIGS. 5A and 5B illustrate negative electrode and FIGS. 5C and 5D illustrate positive electrode.

In FIG. 5A, a negative electrode collector includes a negative electrode active material coated area 41 and an uncoated area that is not coated with the negative electrode active material and serves as the negative electrode collector tab 47.

The negative electrode with the negative electrode collector tab 47 as shown in FIG. 5B can be made by forming a substantially pentagonal uncoated area encircled by the outer lines extending from both sides of the negative electrode active material coated area, two cut lines 91, 92 and the boundary between the negative electrode active material coated area and the uncoated area.

As is the case with the negative electrode shown in FIG. 2, the negative electrode active material uncoated area of the negative electrode collector made of a metal foil is cut along the extensions of the active material coated area and the two straight cut lines as shown in the figure and are therefore less susceptible to burring.

As with the negative electrode collector tab, the positive electrode collector tab 57 as shown in FIG. 5D can be formed on the positive electrode by cutting the positive electrode active material uncoated area along the cut lines 91, 92 as shown in FIG. 5C.

A process to produce the electrode of the present invention by coating a current collector with an electrode active material will now be described.

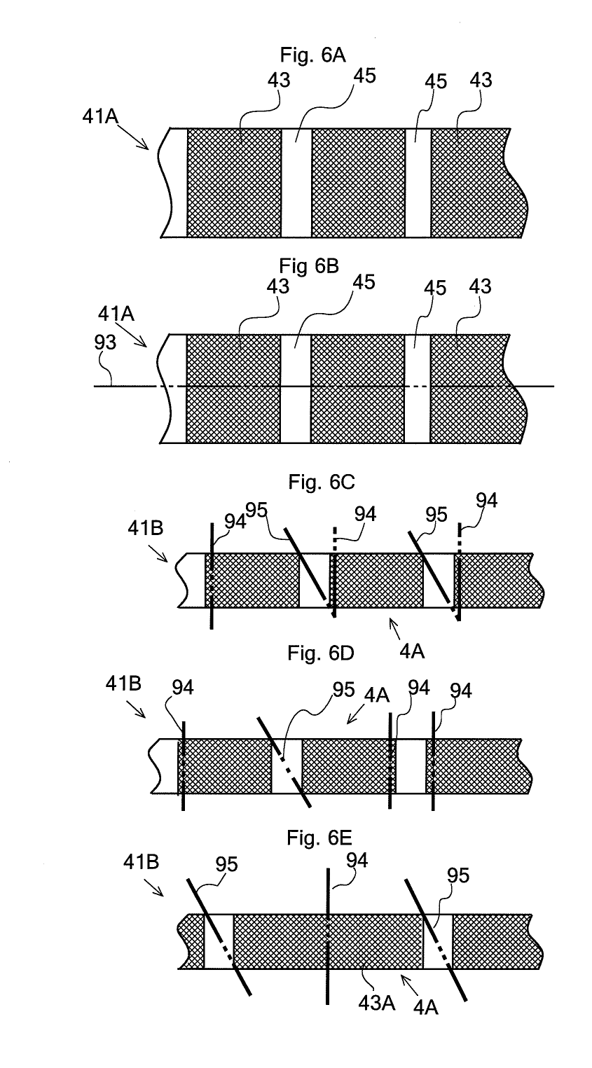

FIG. 6 is a diagram illustrating a production process of an electrode of the present invention with reference to a negative electrode. Positive electrodes can be produced in the same manner.

As shown in FIG. 6A, a paste of a negative electrode active material is applied to a band-shaped negative electrode collector 41A. The negative electrode active material is applied in a discontinuous manner so that the negative electrode active material coated areas 43 and the negative electrode active material uncoated areas 45 are formed. The size of the uncoated area 45 is determined depending on the size of the negative electrode collector tab to be formed.

Subsequently, the band-shaped collector coated with the negative electrode active material is cut along the cut line 93 as shown in FIG. 6B so that the cut collector has a width corresponding to the width of a single negative electrode to form a stacked secondary battery.

In an example shown in FIG. 6C, the band 41B cut to have a width of a negative electrode is cut in each negative electrode active material coated area 43 near the adjacent negative electrode active material uncoated area 45 along the cut lines 94 perpendicular to the length of the band. At the same time, the uncoated area 45 is cut along the cut lines 95 oblique to the length of the band to form negative electrodes 4.

The process can produce negative electrodes 4 each having a uniform shape relative to the length of the band and can thus eliminate the need for subsequent operation, such as a rotation.

In an example shown in FIG. 6D, the band 41B cut to have a width of a negative electrode is cut along the cut lines 94 perpendicular to the length of the band on both sides of the adjacent negative electrode active material coated areas 43 arranged one next to another near an intervening negative electrode active material uncoated area 45. At the same time, the uncoated area 45 arranged between the negative electrode active material coated areas is cut along the cut lines 95 oblique to the length of the band to form negative electrodes 4.

In an example shown in FIG. 6E, negative electrode active material coated areas 43A each having a length corresponding to two negative electrodes and intervening negative electrode active material uncoated areas 45 are formed on the band 41B that has been cut to have a width of a negative electrode.

The coated area 43A is cut at its center as viewed along the length of the band, along the cut line 94 perpendicular to the length of the band. At the same time, the uncoated area 45 is cut along the cut line 95 oblique to the length of the band to form negative electrodes 4.

Although each of the processes shown in FIGS. 6D, 6E can reduce the amount of waste materials, the negative electrodes 4 produced need to be aligned relative to one another, for example, by rotation.

One embodiment of an assembled battery in which multiple stacked secondary batteries are connected to one another will now be described with reference to drawings.

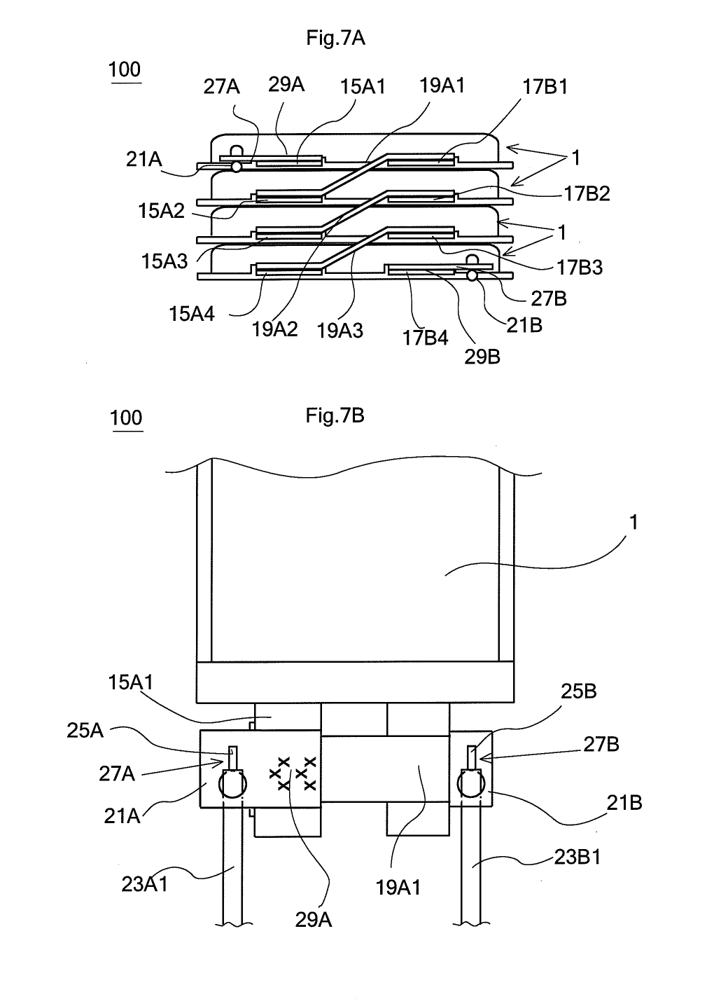

FIG. 7 is a diagram illustrating one embodiment of an assembled battery. Specifically, FIG. 7A is a front view as viewed from the side of the electrode leads and FIG. 7B is a plan view in which part of the assembled battery opposite to the electrode leads is omitted.

An assembled battery 100 includes four stacked secondary batteries 1 having electrode leads 15A2 to 15A4 and 17B1 to 17B3 that are connected in series via connector conducting members 19A1 to 19A3. Rectangular planar tab terminals 21A, 21B are connected to electrode terminals 15A1, 17B4 for connection to outside circuits.

Lead cores 25A, 25B of the connecting leads 23A1, 23B are connected to the tab terminals 21A, 21B at the connection areas 27A, 27B by means of, for example, soldering. The connecting leads are first connected to the tab terminals 21A, 21B, which in turn are connected to the electrode terminals at the joints 29A, 29B by means of, for example, spot welding.

As described above, multiple stacked secondary batteries can be electrically connected in series, in parallel, or in series-parallel in one unit to provide an assembled battery having any output voltage or output current.

These batteries may also be equipped with a protective circuit, a control circuit or the like.

A stacked secondary battery of the present invention provided in the form of a lithium ion battery will now be described.

A positive electrode consists of an aluminum foil to serve as the positive electrode collector with a positive electrode active material deposited thereon.

To make the positive electrode, a positive electrode active material including lithium-transitional metal composite oxides doped or undoped with lithium, such as lithium-manganese composite oxides, lithium-cobalt composite oxides, lithium-nickel composite oxides or lithium composite oxides containing manganese, cobalt, nickel or the like, a conductivity-imparting agent, such as carbon black, and a binder, such as polyfluorovinylidene, are mixed with a solvent such as N-methyl pyrrolidone to form a slurry. The slurry is then applied to the positive electrode collector, dried, and rolled, for example by a roll press, to deposit a layer of the positive electrode active material and thus make the positive electrode.

To make the negative electrode, a negative electrode active material doped or undoped with lithium, such as graphite powder, a conductivity-imparting agent, such as carbon black, and a binder, such as polyfluorovinylidene, are mixed with a solvent such as N-methyl pyrrolidone to form a slurry. The slurry is then applied to a copper foil serving as the negative electrode collector, dried, and rolled, for example by a roll press, to deposit a layer of the negative electrode active material and thus make the negative electrode.

To form a stack to serve as the battery element, a predetermined number of the positive electrodes provided with the positive electrode collector tabs and a predetermined number of the negative electrodes provided with the negative electrode collector tabs are stacked together with separators, formed of polyethylene, polypropylene or other suitable materials, being disposed between the electrodes including where the positive electrode collector tab opposes the negative electrode collector tab.

Subsequently, an electrolyte solution containing a carbonate, such as ethylene carbonate (EC), dimethylcarbonate (DMC) and diethylcarbonate (DEC), a lactone, such as γ-butyrolactone, and an electrolyte, such as LiPF6, is loaded. The positive electrode lead and the negative electrode lead are drawn out and the battery element is sealed in a leakage-free, water-tight film-like casing.

The film-like casing is preferably a film-like casing material consisting of an aluminum foil that has a high thermal adhesion layer of polyethylene, polypropylene or other suitable materials formed on the inside thereof and a high-strength protective layer of nylon, polyester or other suitable materials formed on the outside thereof.

One example of the lithium ion secondary battery produced in accordance with the embodiment of the present invention will now be described. A 10 μm copper foil was used as the negative electrode collector and a 20 μm aluminum foil was used as the positive electrode collector.

As the negative electrode active material, a paste was prepared by blending carbon black to serve as the conductivity-imparting agent, polyfluorovinylidene to serve as the binder, and N-methyl pyrrolidone with graphite.

As the positive electrode active material, a paste was prepared as with the negative electrode by blending carbon black to serve as the conductivity-imparting agent, polyfluorovinylidene to serve as the binder, and N-methyl pyrrolidone with LiMn₂O₄ to serve as the positive electrode active material.

The respective pastes are applied to the negative electrode collector and the positive electrode collector except for the areas to form the negative electrode collector tab and the positive electrode collector tab. The positive electrode collector and the negative electrode collector were each cut into a shape as shown in FIG. 2 to form a positive electrode collector tab and a negative electrode collector tab.

Subsequently, four positive electrodes and five negative electrodes were stacked together with polypropylene separators disposed in-between to make a lithium ion secondary battery of the outer dimension of 82×150×4 mm. It turned out that the lithium ion battery produced had favorable properties without any burrs formed on the negative electrode collector tab or on the positive electrode collector tab.

### INDUSTRIAL APPLICABILITY

The stacked secondary battery of the present invention has a negative electrode collector tab and a positive electrode collector tab that are integrally formed with a negative electrode and a positive electrode formed of metal foil collectors and that are cut along simple lines. Thus, the negative electrode collector tab and the positive electrode collector tab can be cut out easily. In addition, cutting along simple lines is less likely to result in formation of burrs and facilitates adjustment of punching molds when the collector tabs are cut by punching, thus resulting in improved productivity of stacked secondary batteries.

### REFERENCE SIGNS LIST

1: Stacked secondary battery, 2: Battery element, 3: Film-like outer casing, 4: Negative electrode, 5: Positive electrode, 6: Separator, 8: Opposing area, 9, 91, 92, 93: Cut line, 15: Negative electrode lead, 15A1 to 15A4: Electrode leads, 17: Positive electrode lead, 17B1 to 17B3: Electrode lead, 19A1 to 19A3: Connector conducting member, 21A, 21B: Tab terminal, 23A, 23B: Connecting lead, 25A, 25B: Lead core, 27A, 27B: Connection area, 29A, 29B: Joint, 41: Negative electrode collector, 41A, 41B: Band, 43: Negative electrode active material coated area, 43A: Coated area (for negative electrode active material) having a length corresponding to two negative electrodes, 45: Negative electrode active material uncoated area, 47 Negative electrode collector tab, 51: Positive electrode collector, 53: Positive electrode active material coated area, 55: Positive electrode active material uncoated area, 57: Positive electrode collector tab, 63 Nonporous film, 91, 91, 93, 94: Cut line, 100: Assembled battery

1. A stacked secondary battery, comprising:
a positive electrode collector formed of a metal foil and a negative electrode collector formed of a metal foil;
a positive electrode formed of the positive electrode collector including a positive electrode active material coated area coated with a positive electrode active material and a positive electrode active material uncoated area not coated with the positive electrode active material, the positive electrode active material uncoated area serving as a positive electrode collector tab;
a negative electrode formed of the negative electrode collector including a negative electrode active material coated area coated with a negative electrode active material and a negative electrode active material uncoated area not coated with the negative electrode active material, the negative electrode active material uncoated area serving as a negative electrode collector tab;
a separator disposed between the positive electrode and the negative electrode, in which the positive electrode collector tab and the negative electrode collector tab are stacked together with a part of the positive electrode collector tab opposing a part of the negative electrode collector tab, and the separator is also disposed between the opposing parts of the collector tabs; and
a positive electrode lead connected to the positive electrode
collector tab and a negative electrode lead connected to the negative electrode collector tab, in which the positive electrode lead and the negative electrode lead extend out from the same end surface of the stack of the positive electrode, the separator and the negative electrode, and are drawn out from an outer casing.

2. The stacked secondary battery according to claim 1, wherein
the active material coated areas of the negative electrode and the positive electrode each have a rectangular shape, and the positive electrode tab and the negative electrode tab each have a decreasing width as the positive electrode tab and the negative electrode tab extend away from the boundary with the positive electrode active material coated area or the negative electrode active material coated area.

3. The stacked secondary battery according to claim 1, wherein
the positive electrode tab and the negative electrode tab have a substantially triangular, trapezoidal, or pentagonal shape.

4. The stacked secondary battery according to claim 1, wherein
the part of the separator that opposes the positive electrode collector tab and the negative electrode collector tab has a nonporous film applied thereto or is treated by heat-clogging process.

5. The stacked secondary battery according to claim 1, wherein
the positive electrode active material includes a lithium-manganese composite oxide.

6. A method for producing a stacked secondary battery, comprising the steps of:
applying a paste of a positive electrode active material or a negative electrode active material to at least one surface of a band-shaped metal foil along the length of the band while providing an uncoated area for forming a collector tab;
forming a unit electrode body by cutting the band along the length so that the cut band has a width equal to the width of a positive electrode or a negative electrode;
forming a positive electrode and a negative electrode having a collector tab by cutting the uncoated area of the unit electrode body along one or two cut lines extending across the width of the body so that the cut uncoated area has a decreasing width as the uncoated area extends away from the boundary with the active material coated area;
stacking the positive electrode and the negative electrode together with a separator disposed in-between;
connecting the collector tabs of the positive electrodes and the negative electrodes with one another and connecting a positive electrode lead and a negative electrode lead to the respective electrode tabs; and
sealing the stack in a film-like casing.

7. An assembled battery, comprising:
a positive electrode collector formed of a metal foil and a negative electrode collector formed of a metal foil;
a positive electrode formed of the positive electrode collector including a positive electrode active material coated area coated with a positive electrode active material and a positive electrode active material uncoated area not coated with the positive electrode active material, the positive electrode active material uncoated area serving as a positive electrode collector tab;
a negative electrode formed of the negative electrode collector including a negative electrode active material coated area coated with a negative electrode active material and a negative electrode active material uncoated area not coated with the negative electrode active material, the negative electrode active material uncoated area serving as a negative electrode collector tab;
a separator disposed between the positive electrode and the negative electrode, in which the positive electrode collector tab and the negative electrode collector tab are stacked together with a part of the positive electrode collector tab opposing a part of the negative electrode collector tab, and the separator is also disposed between the opposing parts of the collector tabs; and
a positive electrode lead connected to the positive electrode collector tab and a negative electrode lead connected to the negative electrode collector tab, in which the positive electrode lead and the negative electrode lead extend out from the same end surface of the stack of the positive electrode, the separator and the negative electrode, and are drawn out from an outer casing, and the positive electrode leads or the negative electrode leads of a stacked battery are connected in series, in parallel, or in series-parallel.
